(19) United States
(12) Patent Application Publication
(10) Pub. No.: US 2016/0047644 A1
(43) Pub. Date: Feb. 18, 2016

(54) PHASE-INVERTED SIDELOBE-ANNIHILATED OPTICAL COHERENCE TOMOGRAPHY

(71) Applicant: The University of Hong Kong, Hong Kong (CN)

(72) Inventors: Kenneth Kin Yip WONG, Hong Kong (CN); Chi ZHANG, Hong Kong (CN)

(73) Assignee: THE UNIVERSITY OF HONG KONG, Hong Kong (CN)

(21) Appl. No.: 14/458,634

(22) Filed: Aug. 13, 2014

(51) Int. Cl. G01B 9/02

(52) U.S. Cl. CPC G01B 9/02055; G01B 9/02091; G01B 9/02004; G01B 9/02044

(57) ABSTRACT

An optical coherent tomographic imaging system includes means for introducing a 180-degree phase inversion in the interference fringes, and generating a two-peak shape point spread function (PSF) in the frequency domain for the interference-based tomographic imaging system. The system further includes means for achieving sharper resolution than the diffraction-limited spectral bandwidth in the tomographic imaging system through subtracting the two-peak shape from the original Gaussian PSF. Means are provided for removing the ghost fringes in the tomographic imaging system, which is introduced by the self-interference between the different layers of the sample arm. The apparatus is configured to realize the real-time super-resolution swept-source optical coherent tomography (OCT) such that the sensitivity of the system is enhanced by suppressing the noise floor in the frequency domain, as well as removing the ghost fringes.

### BACKGROUND OF THE INVENTION

The capture of tomographic images is one of the most essential measurement techniques in biophotonic systems, especially in biomedical applications, such as in the field of ophthalmology or when used in combination with endoscopy, for example for cardiovascular medicine. Other medical applications also include dental or skin tissue examinations or other areas of medicine. Optical coherence tomography (OCT) is a non-contact and non-invasive imaging technique to obtain fine resolution and three-dimensional cross-sectional images of tissue structure on the micron scale (μm), such as the retina, cornea, anterior chamber of eyes, cell imaging, tissue characterization, live blood flow imaging, etc. It avoids the physical cutting of samples, thereby rendering non-invasive in vivo imaging possible (optical biopsy).

Conventional optical coherence tomography (OCT) has recently been accepted in both industry and the laboratory, due to its fine resolution and non-invasive nature. It provides depth information (optical biopsy) and avoids the physical cutting of samples, thereby rendering non-invasive in vivo imaging possible. OCT is able to obtain ˜10 μm resolutions and 2-3 mm imaging depths in highly scattering biological tissues based on low-coherence interferometery and fiber optic technology.

In its most basic form, time-domain OCT (TD-OCT) consists of a Michelson-type interferometer with a focused sample arm beam and lateral-scanning mechanism. FIG. 1 shows the modes of operation of conventional OCT systems. OCT relies on back-scattered light from different regions of the sample to create a three dimensional (3-d) map. It uses different localization techniques to obtain the information in the axial direction (along the optical beam, z-axis) and the transverse direction (plane perpendicular to the beam, x-y axes). The information in the axial direction is obtained by estimating the time of flight of light reflected from different layers in the sample. Since it is not easy to perform direct measurement of the difference in the time of flight of light, OCT employs indirect measurement of the time of flight using what is called “low-coherence interferometry.” In low-coherence interferometers a light source 10 with a broad optical bandwidth is used for illumination. FIG. 1(a). The light coming out of the source is split by a beam splitter 12 in directions called the reference and sample arms of the interferometer. The light from each arm is reflected back and combined at the detector 14. The light in the reference arm is reflected by a mirror 13 and the light in the sample arm can be reflected by another mirror during set up, but during operation it is reflected by layers of the sample 15. The interference effect, (fast modulation of in intensity) is seen at the detector only if the time which is travelled by light in the reference and sample arms is nearly equal. Thus the presence of interference serves as a relative measure of the distance travelled by the light.

OCT uses this concept by replacing the mirror in the sample arm with the sample 15 to be imaged, which sample has several reflecting structures. The reference arm is then scanned in a controlled manner and the light intensity is recorded on the detector. FIG. 1(b). The interference pattern shows up when the mirror is nearly equidistant to one of the reflecting structures in the sample. The distance between two mirror locations where the interference occurs corresponds to the optical distance between the two reflecting structures of the sample in the path of the beam.

The transverse or x-y localization of the sample structure is simpler. The broadband light source beam that is used in OCT is focused to a small spot (on order of few microns) and scanned over the sample. FIG. 1(d). For example a narrow band source such as a laser 18 may be used. Even though the light beam passes through different structures in the sample, the low-coherence interferometry described above, helps to separate out the amplitude of the reflections from individual structures in the path of the beam.

Fourier-domain OCT provides an efficient way to implement the low-coherence interferometry. Instead of recording the intensity at different locations of the reference mirror, the intensity is recorded as a function of wavelengths or frequencies of the light. The intensity modulations when measured as function of frequency are the spectral interference. The rate of variation of intensity over different frequencies is indicative of the location of the different reflecting layers in the samples. It can be shown that a Fourier transform of spectral interference data provides information equivalent to the one obtained by moving the reference mirror.

There are two common methods of obtaining spectral interference in OCT. One involves using a spectrometer as the detectors and is called Spectral-domain OCT (“SD-OCT”) (FIG. 1(b)). In that mode the light is split into different wavelengths during detection. The other method involves splitting the light into different wavelengths at the source. This is called Swept-source OCT (“SS-OCT”)(FIG. 1(d)). In that mode the incident light changes the wavelength as a function of time and the temporal output of the detector is converted to spectral interference.

Fourier-domain allows for much faster imaging as all the back reflections from the sample are being measured simultaneously. This speed increment introduced by Fourier-domain OCT opened a whole new arena of applications. Video-rate OCT imaging can be easily obtained using commercial systems.

To afford better diagnostic ability, rapid acquisition rates are necessary to reduce artifacts due to patient motion, to capture fast dynamics and to generate 3D volumetric images within reasonable time constraints. Increases in OCT imaging speed have been achieved with the SS-OCT detection technique.

For a typical SS-OCT system, different reflecting depth would result in different interference frequencies after the signal detector, i.e., the interferometer. Then it is required to perform the Fourier transformation on the interference fringes in order to obtain the tomographic images. FIG. 1(c). In such a situation the axial resolution will be limited by the bandwidth of the laser source deployed. For example, at 1310-nm, around 80-nm wavelength bandwidth is required to achieve 10-μm resolution. However, it is not easy to further increase the source bandwidth in the SS-OCT system, since highly coherent source is required to obtain deeper imaging depth. Further, the principle of conventional OCT imaging, i.e., the different depth of the sample introduceds temporal delay, makes the swept-source in two arms interference at different frequency. Suppost the swept bandwidth is 80 nm and centered at 1550 nm, the temporal aperture is 10 is, and the single scattered layer sample is delayed by 200 μm. The resolution is then 10.6 μm, which is close to the theoretical calculation of 12.4 μm for the resolution.

The resolution of the OCT is fully determined by the spectral bandwidth. Thus, to achieve better resolution, larger spectral bandwidth is required. This process is similar to the resolution of the spatial microscope, which is limited by the numerical aperture (NA) of the objective lens. The similarity of these two schemes is connected by the space-time duality, since the Fourier transformation process can be achieved at the focal plane (Fourier plane) of the imaging modality. Fortunately, there are some ingenious imaging modalities in achieving super-resolution in microscopic applications, without increasing the NA, e.g. the stimulated emission depletion (STED) microscopy in the fluorescence imaging. It achieves super-resolution by generating a doughnut-shape de-excitation spot to subtract from the original diffracted-limited spot, such that the remaining area will become much smaller in the spot size.

### SUMMARY OF THE INVENTION

Inspired by STED microscopy in the spatial domain, as well as the space-time duality, the present inventors discovered that the OCT spatial process can be transform into the temporal domain, and this turns out to be particularly suitable for an OCT system. As a result, of this insight, the present inventors have developed a new method to capture tomography images which they call Phase-inverted sidelobe-annihilated optical coherence tomography (PISA-OCT) in which super-resolution is achieved by suppressing the sidelobe of the original pulse profile. This results in captured images with higher resolution than those achieved with conventional swept-source OCT (SS-OCT).

Phase-inverted sidelobe-annihilated optical coherence tomography (PISA-OCT) is an entirely new scheme, which allows the capture of tomography images (layers) with a higher resolution than the diffraction limit, based on one of the fastest and most promising optical tomography modalities, i.e., swept-source OCT (SS-OCT). For a typical SS-OCT system, since the illuminating light is a swept-source, different reflecting depth would result in different interference frequencies after the interferometer. Then it is required to perform the Fourier transformation on the interference fringes in order to obtain the tomographic images, and its “line width” (or resolution) will be limited by the bandwidth of the laser source deployed. By optically engineering the point spread function (PSF) of one frame into a two-peak (or doughnut) shape, while the other frame is kept with the original Gaussian shape, a super-resolution image can be obtained by the subtraction of these two frames, because the doughnut shape creates a negative value around the real layer. Benefitting from the subtraction, the DC component and the noise level will be suppressed, thus better signal-to-noise ratio (SNR) and detection sensitivity are obtained. In addition to narrowing the resolution of the tomographic layers, the PISA-OCT system also eliminates those ghost fringes introduced by the interference between different sample layers. Unlike the advanced super-resolution technologies in the microscope system (through the spatial domain), this invention achieves super-resolution in a tomography system (through the temporal domain) by PISA-OCT, which will perform way better than the conventional OCT systems available in the market.

By optically engineering the point spread function (PSF) of one frame into a two-peak (or doughnut) shape in the frequency domain, while the other frame is kept as the original Gaussian shape, a super-resolution image is obtained by the subtraction of these two frames, because the doughnut shape create negative value around the real layer. In the PISA-OCT scheme, only a temporal phase modulation (a stepped π-phase shift on the reference signal) is required in the reference arm, which is a simple and low-cost solution.

The PISA-OCT system makes possible a first generation super-resolution tomography product; or alternatively, it can also provide an upgrade option to the conventional SS-OCT on the reference arm. Furthermore, the current manifestation in the optical domain can be further extended to other electromagnetic wave devices such as those in the terahertz (THz) and microwave frequencies.

The advantages of PISA-OCT include: 1) minimal adjustment on the existing swept-source OCT setup (i.e., by simply introducing a phase modulator in the reference arm); 2) achieving sharper resolution without increasing the required bandwidth of the swept-source; 3) removing ghost fringes introduced by the self-interference between sample layers, similar to the balanced detection technology; and 4) enhancing the sensitivity by suppressing the noise floor. Therefore, the SA-OCT system provides a very simple solution in achieving better tomographic imaging quality, based on the conventional swept-source OCT.

### BRIEF DESCRIPTION OF THE DRAWINGS

The foregoing and other objects and advantages of the present invention will become more readily apparent when considered in connection with the following detailed description and appended drawings in which like designations denote like elements in the various views, and wherein:

FIGS. 1(a)-1(d) are diagrams showing the arrangement and different modes of operation of conventional optical coherence tomography;

FIG. 2 is a diagram illustrating the principle of the PISA-OCT in generating a two-peak shape;

FIG. 3 is an experimental setup of the PISA-OCT versus a conventional swept-source OCT with only the reference arm modified

FIGS. 4(a)-4(g) show the operational sequence of the PISA-OCT system

FIG. 5(a)-5(g) show characteristic waveforms of the PISA-OCT;

FIG. 6(a)-6(c) illustrate the ghost imaging feature of the OCT system; and

FIG. 7(a)-7(h) compare images from a conventional swept source OCT versus the PISA-OCT for fish eye and a human finger; and

FIGS. 8(a)-8(h) compare images from a conventional swept source OCT versus the PISA-OCT for orange slices and an onion slices.

### DETAILED DESCRIPTION OF AN EXEMPLARY EMBODIMENT OF THE INVENTION

Phase-inverted sidelobe-annihilated optical coherence tomography (PISA-OCT) leverages a π-step phase modulation to introduce a two-peak shape in the frequency domain. This two-peak shape causes the system to achieve a sharper resolution than the resolution that is diffraction-limited by the spectral bandwidth. The essential part of PISA-OCT is introducing a phase modulator in the reference arm of a conventional swept-source OCT.

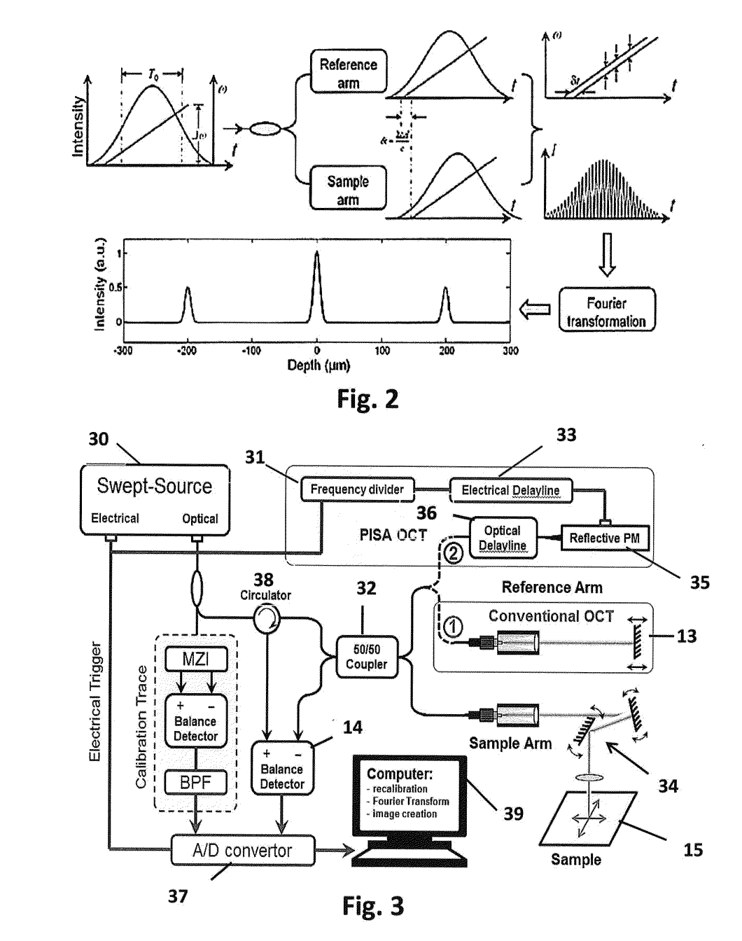

A conventional swept-source OCT, and its working principle is shown in FIG. 2. In this arrangement because of the different depths of the sample, the interference signal from the swept-source in the reference and sample arms introduces a temporal delay that is expressed as different frequencies. By only considering a single surface of the sample in the sample arm, this swept-source is delayed by δt=2Δd/c. Therefore, we can derive the description of the depth information in the frequency domain:

$$D ( d ) = \sqrt{\frac{π}{ln 2}} {T}_{0} \{ \frac{1}{2} exp [ - \frac{{Δω}^{2}}{{c}^{2} 4 ln 2} {( d - Δ d )}^{2} ] + \frac{1}{2} exp [ - \frac{{Δω}^{2}}{{c}^{2} 4 ln 2} {( d + Δ d )}^{2} ] + exp [ - \frac{{Δω}^{2}}{{c}^{2} 4 ln 2} ] \} \qquad ( 1 )$$

where c is the light velocity, d is the reflective depth in the sample arm, and Δω is the frequency (or spectral) bandwidth. We can obtain the resolution from Eq. (1), i.e. ROCT=2 ln 2λ²/πΔλ. If the swept bandwidth Δλ=80 nm, and is centered at 1550 nm, its temporal aperture is T₀=10 μs, and the single scattered layer sample is delayed by 200 μm. The obtained resolution is 10.6 μm, which matches with the theoretical calculation (12.4 μm). As shown in the bottom of FIG. 2, there are three peaks observed, the first two terms are symmetric in the frequency domain, and the last component is the DC component. To surpass the resolution limitation, a phase modulation with a π-step shape is introduced in the reference arm as shown in FIG. 3. After this phase modulation, there is a 180-degree phase inversion on the interference fringes, which converts the Gaussian frequency peak into two peaks. This is the essential part of PISA-OCT, and under the same assumption, the description of the depth information in the frequency domain can be derived:

$${D}^{′} ( d ) = \sqrt{\frac{π}{ln 2}} {T}_{0} \{ exp ( - \frac{{Δω}^{2}}{4 {c}^{2} 4 ln 2} ) + \sqrt{2} \vert {D}_{+} [ \frac{Δω ( d - Δ d )}{2 c \sqrt{ln 2}} ] \vert + \sqrt{2} \vert {D}_{+} [ \frac{Δω ( d - Δ d )}{2 c \sqrt{ln 2}} ] \vert \} \qquad ( 2 )$$

where D₊(x)=exp(−x²)∫₀^{x}exp(t²)dt is the Dawson function, and D₊(0)=0, its absolute value is shown as a two-peak shape. Similarly, there are three peaks observed in FIG. 2, the first two terms are symmetric in the frequency domain, and the last component is the DC component. Therefore, by subtracting this two-peak profile from the original profile, and substituting the negative part of the difference with zero, a narrower frequency peak can be obtained. After this process, the depth resolution is improved from 10 μm to 2.1 μm. Since the central DC components are identical in both profiles, they will be removed after the subtraction. This feature can be of potential benefit in some situations where low frequency noise is dominant.

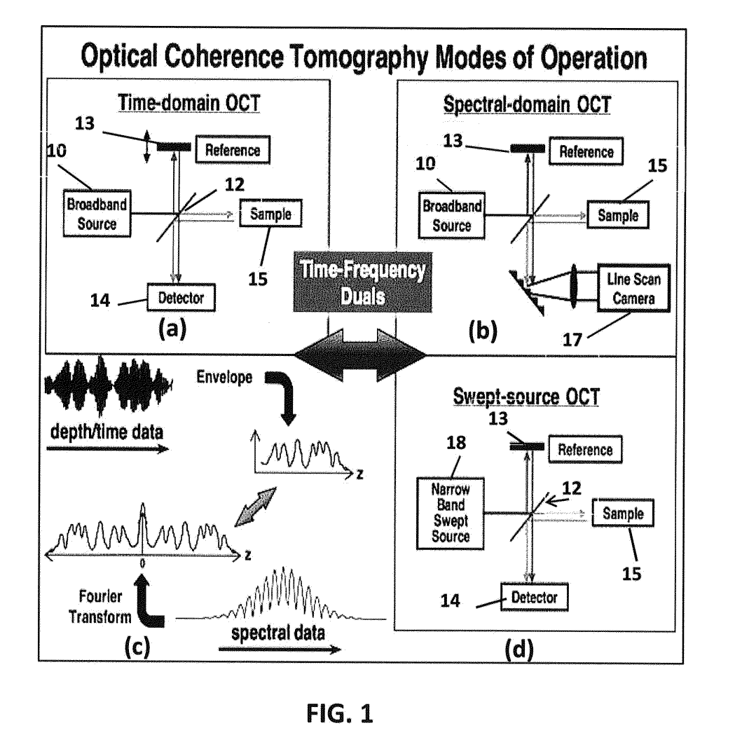

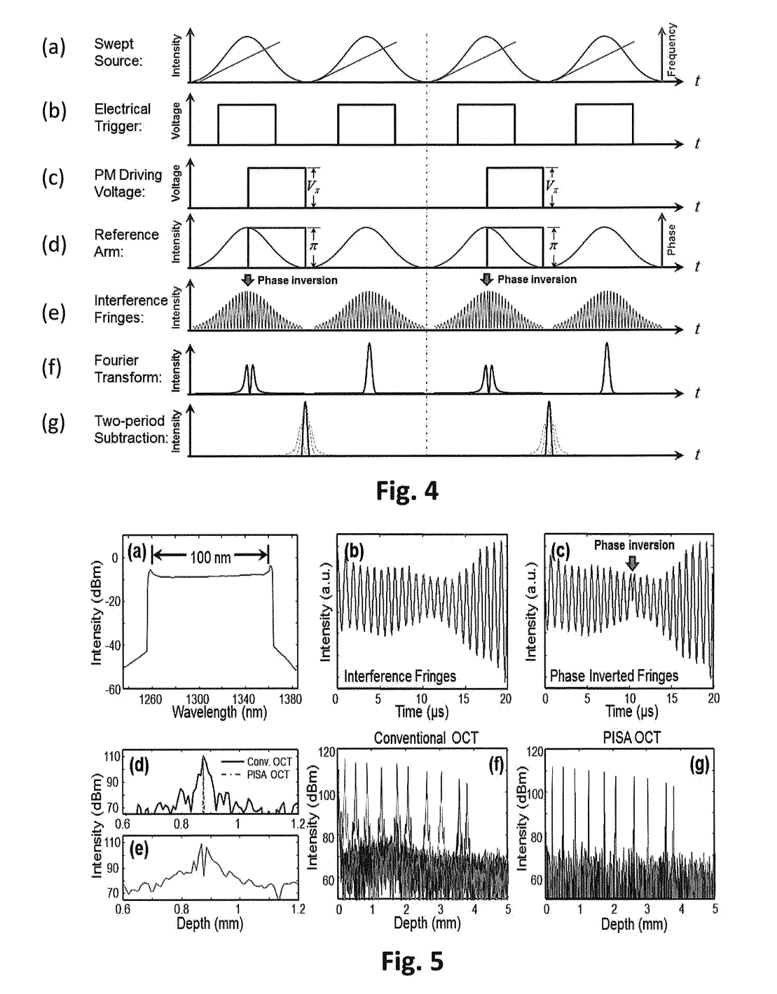

The experimental setup of the PISA-OCT versus the conventional swept-source OCT is shown in FIG. 3. FIG. 4 illustrates the operational sequence of the arrangement in FIG. 3. The setup of FIG. 3 is generally the same as the block diagram of a conventional SS-OCT (FIG. 1(d)), except for the reference arm, where the reflective mirror 13 (path 1) is replaced with a reflective phase modulator 35 (path 2). In FIG. 3, the narrow band optical swept source 18 is replaced with combination optical—electrical swept source 30. When operating as a conventional OCT the optical signal (FIG. 4(a)), which is guided by an optical fiber, passes through circulator 38 to 50/50 coupler 32, which acts as a beam splitter like mirror 12 in FIG. 1A so that a portion of the light passes along path 1 to reference mirror 13 and part passes into the sample arm to engage scanner 34, which causes it to scan the sample 15. The reflected optical signals pass back to coupler 32 where they are combined. One of the outputs of the coupler goes directly to the minus input of balance detector 14 and the other goes through circulator 38 to the plus input of balanced detector 14 depending on the cycle. The balanced detector works within a single period to perform a conventional balanced detection function, which can enhance 3-dB detection sensitivity, and remove the inter-layer reflection and DC component. The output of detector 14 is the interference fringe (FIG. 4(e)). The analog signal from detector 14 is converted into a digital signal by analog-to-digital (A.D) converter 37, and the digital signal is passed to computer 39 which performs the Fourier transform and displays the image. An electrical trigger signal (FIG. 4(b) from source 30 causes the A/D Converter to sample the analog signal at the proper time.

In order to realize the benefits of the present invention, an electro-optical reference arm is substituted for the pure optical reference arm of the prior art. Thus, the optical signal from coupler 32, instead of using path 1, uses path 2 where it first encounters an optical delay line 36 which helps to balance the timing of the signal with that of the sample arm. The optical signal then engages the reflective pulse modulator 35, which reflects the optical signal and introduces a 180-degree phase inversion in the interference pattern during alternate sweeps of the beam scanner according to its electrical input, which is shown in FIG. 4(c). This electrical input starts with the electrical trigger from swept source 30. It passes through frequency divider 31 and electrical delay line 33. Thus, the optical signal reflected from phase modulator 35 has a phase that depends on its electrical signal. This reflected signal returns to coupler 32 where it is combined with the reflected sample signal. The coupler 32 has two output channels which carry the interference fringes in which there is no phase shift in one cycle and a n-phase shift in the other. The π-phase shift cycle is passed to the minus input of detector 14 and the no phase shift cycle is passed through circulator 38 to the plus input of the detector 14. The difference analog signal is converted into a digital signal by A/D converter 37 and is passed to computer 39 for processing of the Fourier Transform and the generation of the image.

The circulator 38 and balanced detector 14 are designed for balanced detection in the OCT system, which helps to improve the detection sensitivity by 6 dB, and to remove the interlayer interferences. Since there is π-phase shift between the two arms of the 50/50 coupler, the two ports of the balanced detector also receive the interference fringes with π-phase shift, thus the subtraction between these two arms will enhance the fringe intensity by 3 dB, and will remove some intensity noise and DC components.

As shown in FIG. 4, when being operated according to the present invention, the circuit of FIG. 3 has two adjacent periods treated as a single frame, and in the reference arm, the first frame is phase modulated, while the second frame is untouched as in conventional OCT. FIG. 4(e) shows the interference fringes after combining the sample arm and reference arm, and it introduces a phase inversion for the phase modulated period. Therefore, the interference fringes can be obtained from two adjacent frames.

FIG. 4(f) shows that after Fourier transformation, the single frequency peak with the phase inversion has a two-peak shape for the phase modulated period, while the single frequency peak without the phase modulation or inversion remains a single peak with a Gaussian shape. FIG. 4(g) illustrates that by subtracting these two neighboring periods, the narrower pulse width is obtained, i.e., the improved resolution of the PISA-OCT function can be realized. The subtraction is performed based on the intensity part (absolute value) of the signals, with the phase term eliminated. Therefore, the pulse width in the frequency domain is narrowed, and the absolute value subtraction makes this process irreversible.

This PISA-OCT is first characterized by a single reflective mirror in the reference arm, as shown in FIG. 5. In FIG. 5, FIG. 5(a) illustrates the bandwidth of the swept-source. FIGS. 5(b) & (c) illustrate the interference fringes for the periods with/without phase modulation. FIG. 5(d) illustrates the Fourier domain peaks of the conventional OCT and the PISA-OCT. FIG. 5(e) illustrates the subtracted two-peak frequency; and FIGS. 5(f) & (g) illustrate the roll-off measurement of the conventional swept-source OCT versus the PISA-OCT. The interference fringes, for the periods with phase modulation, display a phase inversion in the mid-point of FIG. 5(c), and the Fourier domain peaks of the conventional OCT and the PISA-OCT are shown in FIG. 5(d). By adjusting the depth of the mirror in the reference arm, a comparison can be made of the roll-off curve between these two mechanisms. In FIGS. 5(f) & 5(g), the decreasing slope is almost the same, while each peak in PISA-OCT is much narrower, and the noise floor is also much lower.

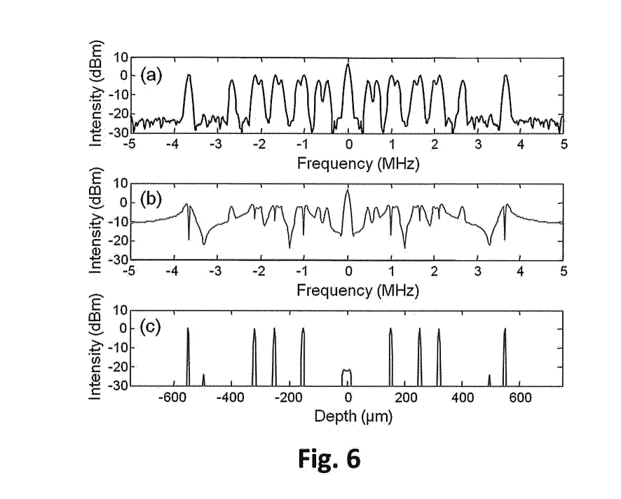

FIG. 6 shows the performance of the ghost imaging features in the OCT system. FIG. 6(a) indicates that in the conventional OCT system, four real peaks generate another six ghost peaks. FIG. 6(b) shows that by adding the phase modulation in the reference arm, those real peaks become a double-peak structure in the frequency domain, while those ghost peaks remain the same as the un-modulated situation. FIG. 6(c) indicates that by subtracting trace (a) and (b), all of the ghost images and DC peak are successfully removed, while keeping the real sharp peaks. Thus, if there are multiple layers involved in the reference arm, as shown in FIG. 6(a) there are usually many ghost fringes introduced by the self-interference between these layers in a conventional swept-source OCT system that does not have balanced-detection. While in the PISA-OCT (FIG. 6(b)), those peaks are essentially modulated into two-peak shapes, but those ghost peaks remain the same. Therefore, once the multiple-layer reference arm is put in the PISA-OCT, all of these ghost fringes will be removed after subtraction, as shown in FIG. 6(c).

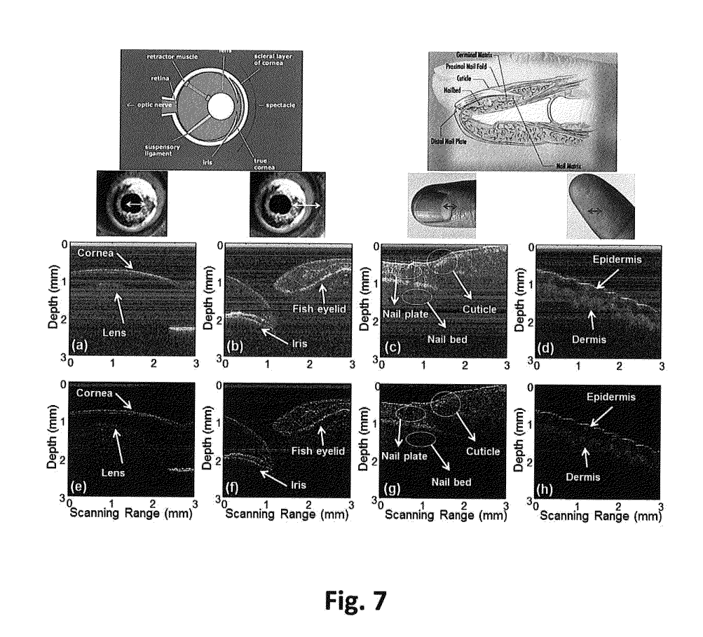

Some bio-samples are measured by the PISA-OCT, and these images are compared with the conventional swept-source OCT, as shown in FIG. 7. FIG. 7 shows the measured the cornea and iris of a fish eye, and the nail plate and the fingerprint of a human finger. In particular, in FIG. 7 images of the conventional swept-source OCT versus the PISA-OCT, where FIG. 7(a) &. 7(e) compare the cornea of a fish eye; FIGS. 7(b) & 7(f) compare the iris of a fish eye; FIGS. 7 (c) & 7(g) compare the nail plate and cuticle of a human finger; and FIGS. 7(d) & 7(h) compare the fingerprint of a human finger. In addition to narrowing the outlines of the structures, the image quality has been greatly improved by removing those ghost fringes and background noise by the PISA-OCT.

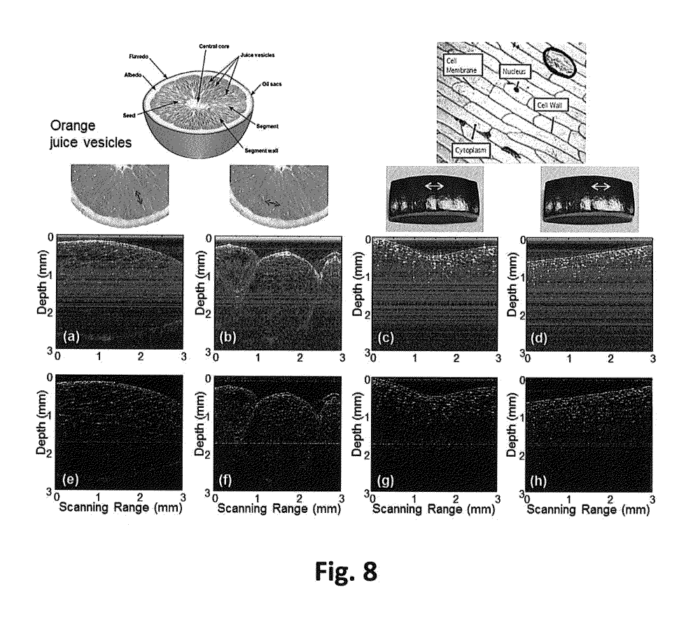

Similar to FIG. 7, FIG. 8 shows a comparison of the scanning of an orange slide and an onion. In particular, in FIG. 8 provides images of the conventional swept-source OCT versus the PISA-OCT, where FIGS. 8(a) & 8(e) compare the cell structure of an orange in the radial direction; FIGS. 8(b) & 8(f) compare the cell structure of an orange in a circumferential direction; FIGS. 8(c) & 8(g) compare the cells of an onion in a circumferential direction and FIGS. 8(d) & (h) compare the cells of an onion in a circumferential direction. In addition to narrowing the outlines of the structures, the image quality has been greatly improved by removing those ghost fringes and background noise by the PISA-OCT.

The following table is a comparison of the PISA-OCT with a commercially available OCT systems, i.e., the Vivolight OCT, the Thorlabs OSC1310V1 and the Thorlabs OCS1300SS.

| | Vivolight | | PISA | | Thorlabs | | Thorlabs | |
|---|---|---|---|---|---|---|---|---|
| | OCT | | OCT | | OCS1310V1 | | OCS1300SS | |
| Swept Source | | | | | | | | |
| Bandwidth | 100 | nm | 100 | nm | 100 | nm | 100 | nm |
| Center Wavelength | 1310 | nm | 1310 | nm | 1310 | nm | 1300 | nm |
| A-Scan Rate | 50 | kHz | 50 | kHz | 100 | kHz | 16 | kHz |
| Average Output Power | >20 | mW | >20 | mW | >20 | mW | >10 | mW |
| Coherent Length | >12 | mm | >12 | mm | >100 | mm | >6 | mm |
| Data Acquisition | | | | | | | | |
| A/D Conversion Rate | 100 | MS/s | 100 | MS/s | 500 | MS/s | 100 | MS/s |
| A/D Resolution | 12-bit | | 12-bit | | 12-bit | | 14-bit | |
| Analog Bandwidth | 200 | MHz | 200 | MHz | 1 | GHz | 100 | MHz |
| Field of View | | | | | | | | |
| A-Scans per Frame | 1000 | | 500 | | 2048 | | 512 | |
| 2D Imaging Size | 1024 × 1000 | | 1024 × 500 | | 2500 × 2048 | | 4000 × 512 | |
| (H × D) | | | | | | | | |
| Points' Depth | 8 | μm | 8 | μm | 8.6 | μm | 6.7 | μm |
| Separation | | | | | | | | |
| Lines' Separation ^{(a)} | 3 | μm | 6 | μm | 1.5 | μm | 6 | μm |
| 2D Imaging Speed | 25 | fps | 25 | fps | 110 | fps ^{(b)} | 25 | fps |
| Maximum Imaging | 10 | mm | 10 | mm | 10 | mm | 10 | mm |
| Width | | | | | | | | |
| Maximum Imaging | 6 | mm | 6 | mm | 12 | mm | 3 | mm |
| Depth | | | | | | | | |
| Imaging | | | | | | | | |
| Depth Resolution | 20 | μm ^{(c)} | 8 | μm ^{(d)} | 16 | μm | 12 | μm |
| (Air) | | | | | | | | |
| Depth Resolution | 15 | μm | 6 | μm | 12 | μm | 9 | μm |
| (Water) ^{(e)} | | | | | | | | |
| Sensitivity | 90 | dB ^{(f)} | 102 | dB ^{(g)} | 105 | dB | 100 | dB |
| R number (Roll-off) | 0.4 | mm/dB | 0.4 | mm/dB | 0.75 | mm/dB | 0.4 | mm/dB |
| −20 dB Roll-off OCT | 8 | mm | 8 | mm | 15 | mm | 4 | mm |
| Depth | | | | | | | | |

The comparisons were conducted under the following conditions indicated by the notes in the table:

(a) Control of the scanning range to 3 mm;

(b) 512 A-scans per frame;

(c) Measurements at 10 dB line width;

(d) Since the single line is too narrow (around 1 μm), the resolution is defined as equal to the depth's point separation;

(e) Assume that the refractive index is 1.5;

(f) Sensitivity depends on the background fringes, which is estimated to be around 90 dB;

(g) The 12-dB sensitivity improvement is calculated from the SNR of the roll-off trace, where the noise ground was decreased by around 6 dB.

The Vivolight OCT, a product of Shenzhen Vivolight Medical Device & Technology Co., Ltd of Shenzhen, P.R.C., and the Thorlabs systems are products of Thorlabs Inc. of Newton, N.J., USA. The Vivolight is the base system of the current invention, i.e., the current invention can be used as an add-on module to the system such that the depth resolution and sensitivity of the system are improved by 50% and 13%, respectively.

Advantages of the present invention include:
1. The DC component and the noise level are suppressed, thus providing better signal-to-noise ratio (SNR) and detection sensitivity.
2. Ghost fringes introduced by the interference between different sample layers are eliminated.
3. The apparatus is simple and easy to deploy by directly replacing the reference arm of an existing SS-OCT system with temporal modulation.
4. Resolution improved by 50% at a cost of about 3% of selling price of the existing SS-OCT system.

While the invention has been particularly shown and described with reference to a preferred embodiment thereof, it will be understood by those skilled in the art that various changes in form and details may be made therein without departing from the spirit and scope of the invention.

We claim:

1. An optical coherent tomographic imaging system comprising:
a light source for generating sample surface-penetrating radiation;
an interferometer with a beam splitter for splitting the radiation into reference and sample arms; the radiation from each arm being returned to the beam splitter and combined to generate an interference pattern;
a detector for receiving the interference pattern;
a beam scanner in the sample arm configured to direct the radiation to a plurality of different locations on a two-dimensional region of a sample surface to scan a plurality of different sites associated with each different location;
a reflective phase modulator in the reference arm configured to introduce a 180-degree phase inversion in the radiation as it is reflected and returned to the beam splitter during alternate sweeps of the beam scanner;
a Fourier Transform generator for generating the Fourier Transform of the interference pattern such that the sweep with the phase inversion creates a two-peak shape point spread function (PSF) in the frequency domain and the interference pattern for the sweep without the phase inversion creates a single peak Gaussian shape; and
a subtraction circuit for subtracting two peak shapes from the single peak shape to affect a sharper resolution than the diffraction-limited spectral bandwidth.

2. An optical coherent tomographic imaging system as claimed in claim 1 wherein the light source is a swept source that produces a laser beam with a sweep frequency and further produces and electrical pulse output in synchronism with the sweep frequency.

3. An optical coherent tomographic imaging system as claimed in claim 2 where in the laser beam is transmitted in the system by fiber optic cables.

4. An optical coherent tomographic imaging system as claimed in claim 2 wherein the phase modulator causes a 180-degree phase inversion based on the electrical pulse output of the light source

5. An optical coherent tomographic imaging system as claimed in claim 4 further including a frequency divider and an electrical delay line between the light source and the phase modulator.

6. An optical coherent tomographic imaging system as claimed in claim 1 further including an optical delay line between the reflective phase modulator and the beam splitter.

7. An optical coherent tomographic imaging system as claimed in claim 1 wherein the output of the detector is converted from an analog signal to a digital signal in an analog-to-digital converter; and
the Fourier Transform generator is a digital computer that operates on the digital signal from the analog-to-digital converter

8. An optical coherent tomographic imaging system as claimed in claim 7, wherein the digital computer converts the Fourier Transform signal into a tomographic image with a resolution greater than that based on the diffraction limit.

9. An optical coherent tomographic imaging system as claimed in claim 1 arranged sot that ghost fringes in the tomographic imaging system, which are introduced by the self-interference between the different layers of the sample arm; are reduced.

10. An optical coherent tomographic imaging system as claimed in claim 1 arranged sot that the sensitivity of the system is enhanced by suppressing the noise floor in the frequency domain.

11. A method of generating an optical coherent tomographic image comprising the steps of:
generating sample surface-penetrating radiation;
splitting the radiation into reference and sample arms; the radiation from each arm being returned and combined to generate an interference pattern;
directing the radiation in the sample arm to a plurality of different locations on a two-dimensional region of a sample surface to scan a plurality of different sites associated with each different location and then to return the radiation;
introducing a 180-degree phase inversion in the radiation in the reference arm as it is reflected and returned during alternate scans of the sample;
combining the radiation from the sample and reference arms to form an interference pattern;
generating the Fourier Transform of the interference pattern such that the sweep with the phase inversion creates a two-peak shape point spread function (PSF) in the frequency domain and the interference pattern for the sweep without the phase inversion creates a single peak Gaussian shape; and
subtracting the two peak shapes from the single peak shape to affect a sharper resolution than the diffraction-limited spectral bandwidth.

12. A method of generating an optical coherent tomographic image as claimed in claim 11 wherein the radiation is a laser beam with a sweep frequency and further including the step of synchronizing the phase inversion with the sweep frequency.
